(19) United States
(12) Patent Application Publication
(10) Pub. No.: US 2009/0320367 A1
(43) Pub. Date: Dec. 31, 2009

(54) PLANT CULTIVATION METHOD AND APPARATUS

(75) Inventors: Mathew S. Smith, Bend, OR (US); John Herrick, Sunriver, OR (US)

Correspondence Address: Schwabe Williamson & Wyatt;PACWEST CENTER, SUITE 1900, 1211 SW FIFTH AVENUE, PORTLAND, OR, 97204, US

(73) Assignee: Smith Herrick Engineering LLC, Bend, OR (US)

(21) Appl. No.: 12/489,651

(22) Filed: Jun. 23, 2009

Related U.S. Application Data
(60) Provisional application No. 61/076,498, filed on Jun. 27, 2008.

(51) Int. Cl. A01G 9/10; A01G 23/02; A01G 9/02; A01G 1/00

(52) U.S. Cl. 47/66.7; 47/65.5; 47/73; 47/87; 47/58.1 R; 47/32.7; 47/32.8

(57) ABSTRACT

Embodiments provide methods and apparatuses for supporting various stages of plant growth through layered soils. In embodiments, a soil adapted for supporting a first plant growth phase (e.g. germination) may be proximal, adjacent, or partially surrounded by a second soil adapted for supporting a subsequent growth phase (e.g. a vegetative phase) such that the roots of the plant encounter the second soil as the plant progresses from the first growth phase to the second growth phase. Some embodiments may provide one or more additional soil layers positioned proximal to the second soil, with the additional soil layers adapted to support additional subsequent plant growth phases. Apparatuses suitable for practicing embodiments of such methods are further provided.

### CROSS REFERENCE TO RELATED APPLICATIONS

The present application claims priority to U.S. Provisional Patent Application No. 61/076,498, filed Jun. 27, 2008, entitled “Plant Cultivation Method and Apparatus,” the entire disclosure of which is hereby incorporated by reference in its entirety.

### TECHNICAL FIELD

The present invention relates to plant cultivation mediums, and in particularly, to a layered soil structure that may enhance and/or augment the growth of a plant through various growth cycles.

### BACKGROUND

The processes of growing plants from seeds typically begins with the gardener placing a specific soil for starting seeds in a container and planting the seed in that container. The plant is cared for and as it grows it reaches a stage where it must be replanted into a different soil which provides the nutrients necessary for the next stage of growth. The conventional means to accomplish this is to remove the plant from the starter soil and place that plant in a larger container, or into a garden plot, which contains a different soil mix. In some cases this process may continue with yet another transplanting to a new type of soil and larger container size. Such processes, however, are labor intensive and costly. More importantly, however, many plant varieties are very susceptible to disturbances in their environment, and can be lost as a result of transplanting due to shock, damage to the root structure, etc. In addition, the plant growth is often delayed because the plant is not immediately transplanted into a new soil mix as soon as it reaches the next stage of growth and/or the plant takes some time to adjust to its new environment.

### BRIEF DESCRIPTION OF THE DRAWINGS

Embodiments of the present invention will be readily understood by the written description along with reference to the accompanying drawings. Embodiments of the invention are illustrated by way of example and not by way of limitation in the accompanying drawings.

FIG. 1 is a cross sectional view of the layered soil in accordance with various embodiments;

FIGS. 2-4 illustrate various stages of plant growth in accordance with various embodiments;

FIGS. 5a-5e illustrate cross sectional views of soil layer configurations in accordance with various embodiments;

FIG. 6 illustrates an embodiment comprising a series of vertically stacked sub-receptacles in accordance with various embodiments;

FIG. 7 illustrates a method for practicing embodiments described herein;

FIG. 8 illustrates an apparatus for supporting plant growth in accordance with various embodiments; and

FIGS. 9a-d illustrate apparatuses for plant cultivation in accordance with various embodiments.

### DETAILED DESCRIPTION OF EMBODIMENTS OF THE INVENTION

In the following detailed description, reference is made to the accompanying drawings which form a part hereof, and in which are shown by way of illustration embodiments in which the invention may be practiced. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

Various operations may be described as multiple discrete operations in turn, in a manner that may be helpful in understanding embodiments of the present invention; however, the order of description should not be construed to imply that these operations are order dependent.

The description may use perspective-based descriptions such as up/down, back/front, and top/bottom. Such descriptions are merely used to facilitate the discussion and are not intended to restrict the application of embodiments of the present invention.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

The term “adjacent” may be used to indicate that two elements (e.g. two soil layers) are positioned near/next to one another, either in direct physical contact or physically separated by one or more other elements. For example, “adjacent soil layers” may be used to indicate soil layers that are in physical contact along an interface, but may also be used to indicate soil layers that are separated by a non-soil layer, other soil layer, and/or a mixing zone.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the phrases “in an embodiment,” or “in embodiments,” which may each refer to one or more of the same or different embodiments. Furthermore, the terms “comprising,” “including,” “having,” and the like, as used with respect to embodiments of the present invention, are synonymous.

For the purpose of the description, the term “soil” or “soil mix” refers to any type of plant cultivation medium, either man made or naturally found, including any mixture of solid, liquid, gas, or other medium that may provide nutrients, including minerals and/or organic matters, to support the growth of a plant in a particular growth stage or stages. Examples of soil or soil mix include, but are not limited to, soil, dirt, mud, broken rocks, sand, mycorrhizae fungi, plant matter, coir/coco, bone meal, fish meal, blood meal, feather meal, diatomaceous earth, clay, mulch, bark dust, sawdust, moss, peat, peat moss, fly ash, diahydro, fertilizers, compost, animal manure, seaweed, paper, cotton, natural fibers, earthworm castings, other organic materials, perlite, and vermiculite, gravel, etc., alone or in any combination. Examples of soil or soil mix may also include, but are not limited to, solid, semi-solid, or gelatinous inorganic matrices suitable for supporting plant growth, such as hydroponic media, inorganic fibers, polystyrene/styrofoam, rock wool, expanded clay, silica, minerals and/or other materials, etc., alone or in combination. Furthermore, the terms “soil” and “soil mix” are synonymous.

The term “non-soil” and/or “non-soil layer” may comprise any material not encompassed within the definition of “soil” and may include glass, metal, fabric, plastics, etc., and may be suitable for purposes such as separation of soil layers, water retention, water drainage, aeration of one or more soil layers, provision of plant nutrients, provision of water, temperature control, etc.

The term “plant” is used in its broadest sense as it pertains to organic material and is intended to encompass eukaryotic organisms that are members of the Kingdom Plantae, examples of which include but are not limited to vascular plants, vegetables, grains, flowers, trees, herbs, bushes, grasses, vines, ferns, mosses, fungi and algae, etc, as well as clones, offsets, and parts of plants used for asexual propagation (e.g. cuttings, pipings, shoots, rhizomes, underground stems, clumps, crowns, bulbs, corms, tubers, rhizomes, plants/tissues produced in tissue culture, etc.).

The terms “growth” and “growth stage” are intended to encompass all plant life stages including but not limited to germination, a vegetative stage, a reproductive stage, a senescent stage, and/or a dormant stage. While terminology used in the art to describe growth stages of various plant species may vary among those species, “growth” and “growth stage” as used herein in accordance with various embodiments may embrace any life cycle stage of a plant. “Growth stage” may refer to one stage, to two or more stages collectively, or may refer to one or more parts of a growth stage (e.g. flowering, first flower, first female flower, fruit/seed production, and/or production of a first, second, third, fourth, or fifth true leaf, etc.). “Growth” may refer to physical growth/development of any part of a plant, and may also be used to refer to a temporal progression by a plant through a “growth stage” that may be unaccompanied by an increase in size or fruit/seed/leaf production (i.e. senescence, dormancy, etc.).

For the purpose of the description, the terms “layer” and “soil layer” are used interchangeably to refer to any physical arrangement of a soil/soil mix. A layer may or may not be shaped in any regular geometric shape, such as a ring, a bucket, a cup, a sphere, a polygon, a cone, a cube, a tube, a cylinder, a circle, a wave, or other geometrical configuration. A layer may or may not have uniform thickness and/or density. A layer may be arranged in any orientation, such as horizontally, vertically, slanted in any angle, or a combination thereof. Embodiments may comprise two or more layers with each layer including a different soil.

The terms “receptacle” and “container” are used interchangeably and are intended to embrace any element with one or more concavities suitable for retaining one or more soil layers.

Embodiments of this invention are directed to a cultivation medium that may include a soil structure wherein a plurality of soil mixes may be located strategically within a container to facilitate and/or enhance the growth of a plant without transplanting. The soil structure may comprise a core layer of soil mix coupled with one or more subsequent layers of soil mix, which provides the plant different soil mixes that are favorable to the plant at various stages of growth.

In various embodiments, a plant may be kept in its receptacle/planting location throughout much if not all of its entire growth cycle, which may eliminate the need to transfer the plant to different containers at various stages of growth or at least reduce the number of transplants that are required to cultivate the plant to the desired maturation level. In addition to enhancing the growth rate of the plants, use of soil structures in accordance with various embodiments may decrease the amount of labor necessary to maintain the growth through various stages. In addition, no plants would be lost as a result of transplanting due to shock and/or various other reasons.

In embodiments comprising two or more layers, layers may be in physical contact with one another and/or may be separated by one or more materials configured to degrade and/or to permit entry by a plant from one layer to the next. For example, a biodegradable material comprising one or more of paper, cellulose, natural/artificial fibers, biodegradable plastics/polymers/polyesters (e.g. polyethylene, starch based polymers, polyhydroxyalkanoates, etc.), cotton, and/or other materials may be positioned between two layers such that the layers are entirely or partially physically separated. Biodegradable materials are known in the art and will not be further described unless necessary for the description of a specific embodiment. In embodiments with three or more layers, some or all of the layers may be separated with one or more such materials.

In various embodiments, a receptacle may retain one or more soil layers adapted to support growth stages of a plant. A receptacle may be constructed of one or more biodegradable materials and/or may be adapted for transplantation while continuing to retain the plant and/or the one or more layers. In some embodiments, a receptacle may be configured to retain a plant until the plant reaches a selected growth stage. In embodiments, a receptacle may be configured to be inserted directly into another receptacle comprising an additional soil layer adapted to support a growth stage of the plant. In an embodiment, a receptacle may include two or more concavities, each concavity suitable for retaining one or more layers and a plant. In some embodiments, two or more receptacles may be mechanically coupled in various configurations (i.e. vertically stacked, coupled side-to-side, etc.).

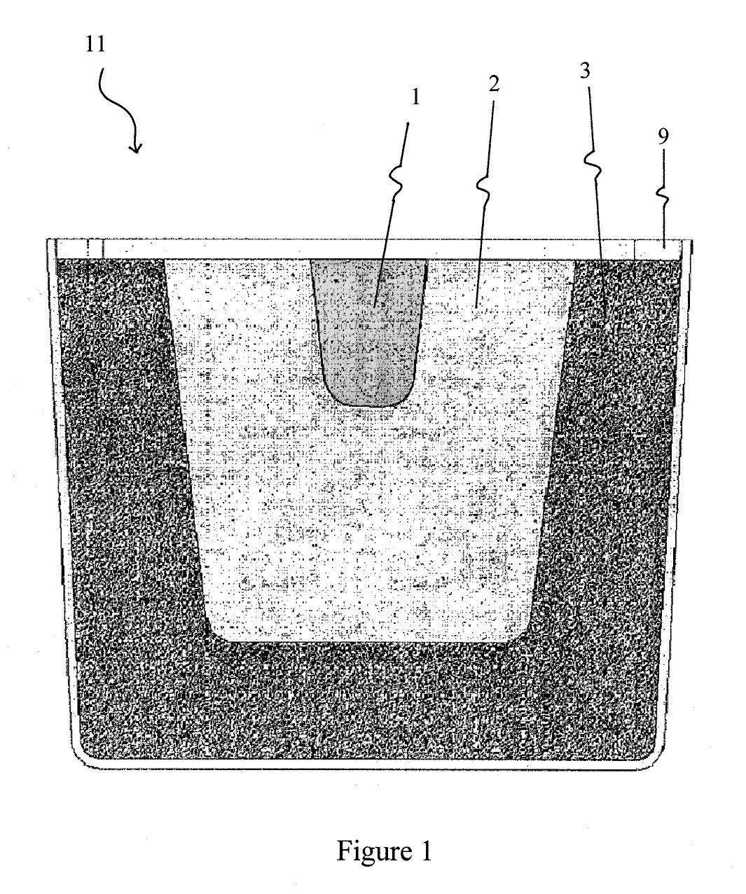

FIG. 1 is a cross sectional view of a layered soil structure 11 in accordance with various embodiments of the present invention. A soil structure may be provided comprising a core or first layer 1 having a soil mix of a first type, which in some embodiments may be particularly suited for enhancing the maturation of seedlings and/or starts during a first growth cycle. A subsequent layer or second layer 2 may be disposed about at least a part of the core layer. The subsequent layer 2 may include a soil mix different from the soil mix of the first type, and in various embodiments may be suited for enhancing the maturation of a plant from the first growth cycle through a second growth cycle (e.g. a transition or juvenile growth cycle).

In various embodiments, the shapes of the core layer and the subsequent layer may be at least partially complementary to each other. In various embodiments, at least a portion of the subsequent layer may at least partially surround a portion of the core layer. In various embodiments, the subsequent layer may be disposed about the core layer without significant gap, space, and/or filler material between the two layers.

In various embodiments, the core layer (shown in the illustrations of embodiments herein as layer 1) may be located in the container generally near the center of the top surface of the cultivation medium. The subsequent layer 2 may be disposed such that it at least partially surrounds layer 1 and spreads outwardly from layer 1 in multiple directions.

In various embodiments, a second subsequent layer or third layer 3 may be disposed in a manner that at least partially surrounds the first subsequent layer 2 and spreading outwardly from the first subsequent layer 2. In various embodiments the third layer 3 may have a soil mixture that is particularly suited for plant growth during a third growth cycle. The shapes of the first subsequent layer and the second subsequent layer may be at least partially complementary to each other. And in various embodiments such layers may be so without a significant gap, space or filler disposed in between the first and the second subsequent layers.

In various embodiments, the core layer 1 may contain a first soil mix that is specifically designed for starting seeds, commonly referred to as the starter soil. The first subsequent layer 2 may contain a second soil mix that may be preferable for the next stage of plant growth. The second subsequent layer 3 may yet contain a third soil mix that may be preferable for the third stage of the plant growth, etc. Research has shown that the plant that has access to different soil mixes that are tailored for different stages of the growth cycles may grow significantly faster than the plant which remains in the starter soil for its pre-transplant life.

Layers 1, 2, and/or 3 may vary in their ratios/concentrations of nitrogen, phosphorus, potassium and/or other nutrients to provide favorable growth conditions at each stage of growth. In some embodiments, layer 3 may be adapted to include an optimal ratio of nutrients for a flowering/fruiting growth stage. In an embodiment, layer 3 may be adapted for a fruiting/flowering growth stage with less nitrogen and more phosphorus/potassium than layer 1 or layer 2. Nitrogen:phosphorus:potassium ratios may vary among layers 1, 2 and 3 in order to adjust growth conditions to meet the nutrient requirements of various plants. Layers 1, 2, and/or 3 may also include varying amounts of other nutrients including calcium, sulfur, magnesium, boron, copper, iron, chloride, manganese, molybdenum and/or zinc. Layer 1 may be adapted to support germination and/or seedling growth. Layer 2 may be adapted to support leafing, physical increase in size of one or more plant parts, and/or further growth and development of roots. In some embodiments, layers may be adapted to accommodate a plant that has completed part of its life cycle; for example, layer 1 may be adapted to support a vegetative stage, a senescent stage and/or a dormant stage.

Layers 1, 2 and/or 3 may vary as to soil density (i.e. soil mass per volume), average particle size, particle size range, porosity, and other physical properties. For example, in the embodiment shown in FIG. 1, layer 3 may have a greater density than layer 2, which may in turn have a greater density than layer 1. Positioning a less dense soil in the center of a layered soil composition with increasingly dense soil layers arranged the less dense soil may provide for optimal growing conditions for supporting a plant's growth from early growth stages to later growth stages. In some embodiments such as the one shown in FIG. 1, layer 1 may be a “starter” soil adapted for germination/early growth stages, layer 2 may be a transplant mix or other transitional soil, and layer 3 may be a potting soil.

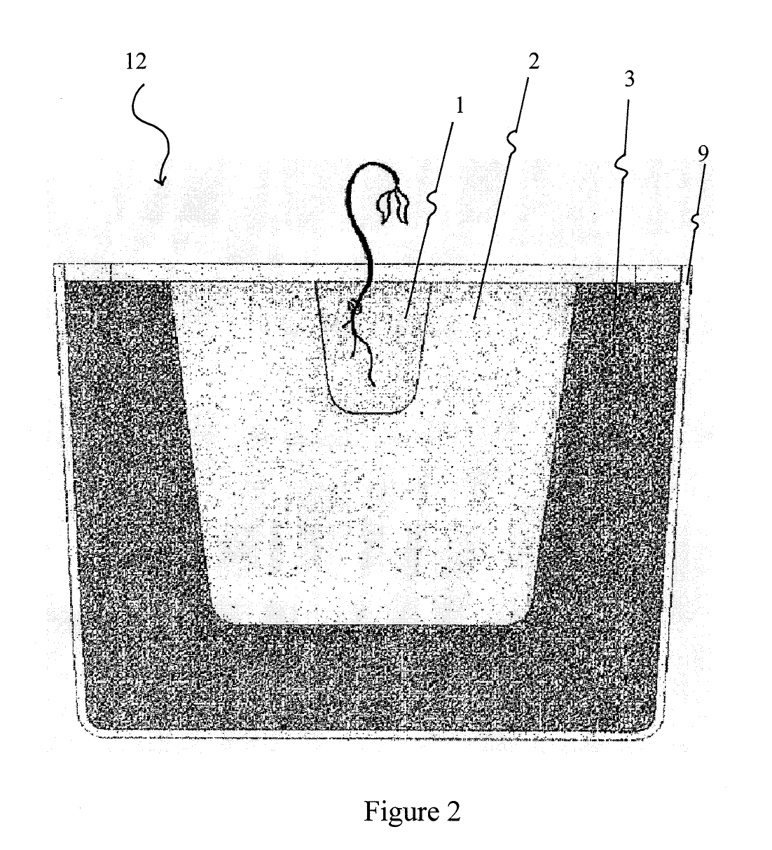

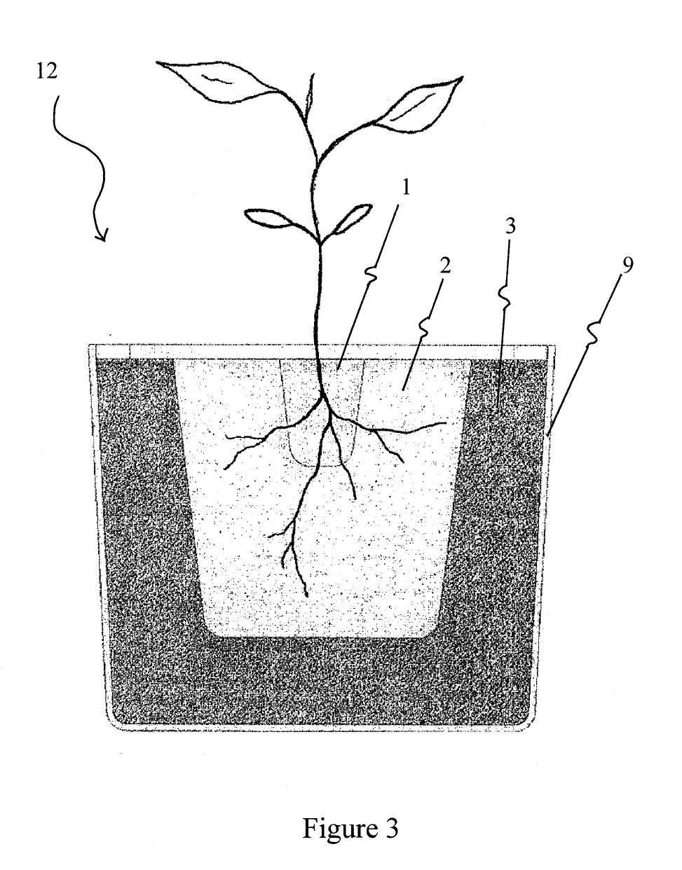

FIGS. 2-4 illustrate various stages of plant growth within a growing apparatus containing a layered soil structure/composition 12 in accordance with various embodiments of the present invention. Initially a seed or seedling may be planted in the starter soil in the core layer 1, which may contain the necessary nutrients for the seed to germinate and/or sprout. In this stage, the root growth may be mainly located in the core layer 1. Eventually, as the root growth progresses, the plant will reach the next stage of a growth cycle. Accordingly, the main root growth will migrate outwardly from the core layer into the subsequent layers 2 and/or 3. The subsequent layers may contain the necessary nutrients for the optimal growth of the plant in the subsequent stages of a particular growth cycle, which may eliminate or reduce the need to transfer the plant to a new container with a new soil mix.

It is understood that the embodiments may be used in any stage or stages of plant growth. The stages of plant growth illustrated in FIGS. 2-4 are by way of example, not by way of limitation. The contents or the exact make-up of the soil mix for the core and/or subsequent layers may vary depending on the plant, the weather, the purpose of the grower, etc. In various embodiments, the number of subsequent layers in a container may vary depending on the plant, the weather, the purpose of the grower, etc. The numbers of subsequent layers illustrated in the FIGS. 1-4 are by way of example, not by way of limitation.

In various embodiments, the configurations, including the location, thickness, depth, size, and/or shape of the core layer and/or the one or more subsequent layers may vary depending on the plant, the container, the weather, the grower, etc. Any gap, space or filler disposed between the core layer and the subsequent layer or between the subsequent layers may vary. The gap or space between the layers illustrated in the FIGS. 1-4 are by way of example, not by way of limitation. In various embodiments, the shape, size, and/or location of the layers may shift or change during the life cycle of the plant. The configurations of the various layers illustrated in the FIGS. 1-4 are by way of example, not by way of limitation.

In various embodiments, such as those shown in FIGS. 1-4, the core layers (e.g. layer 1) may be located near the center of the container and/or may be at least partially surrounded by the subsequent layers (e.g. layer 2, layer 3, etc.). In various embodiments, the core layer and/or the one or more subsequent layers may lay flat in the container with various orders of vertical layering. In various embodiments, the core layer and/or the one or more subsequent layers may or may not be shaped in any regular geometric shape, such as a ring, a bucket, a cup, a sphere, a polygon, a cone, a cube, a tube, a cylinder, etc.

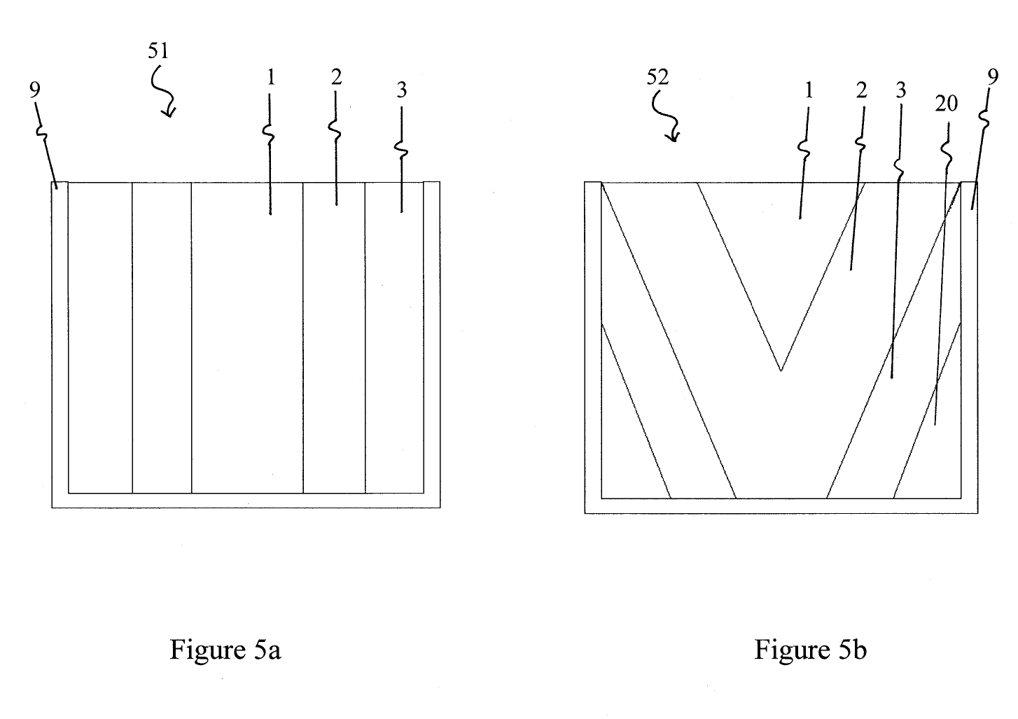

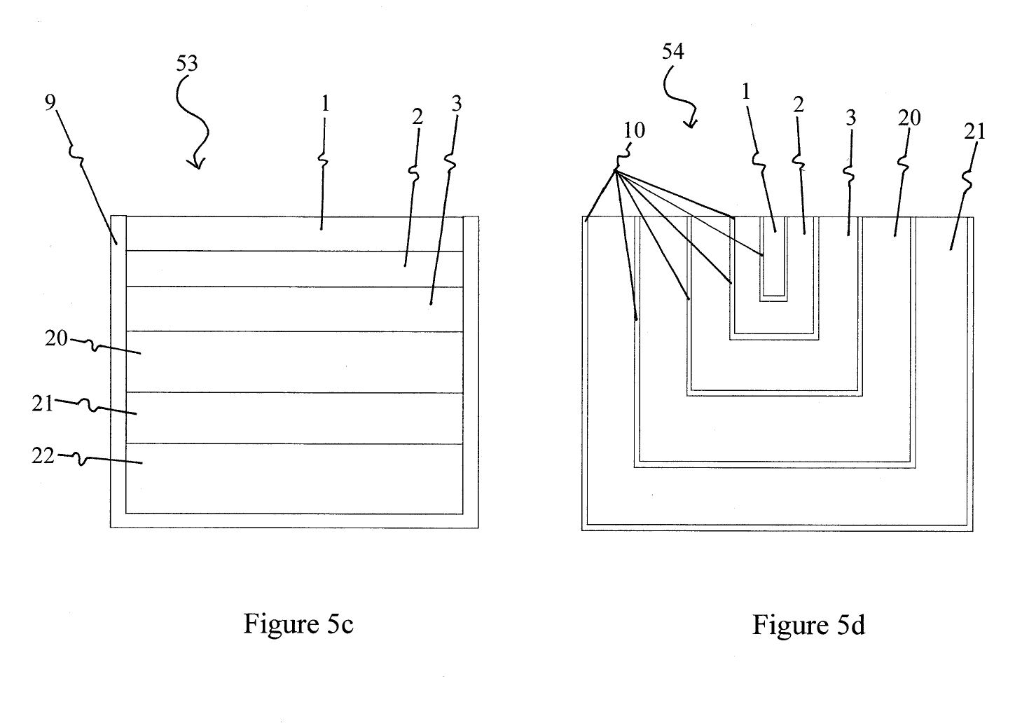

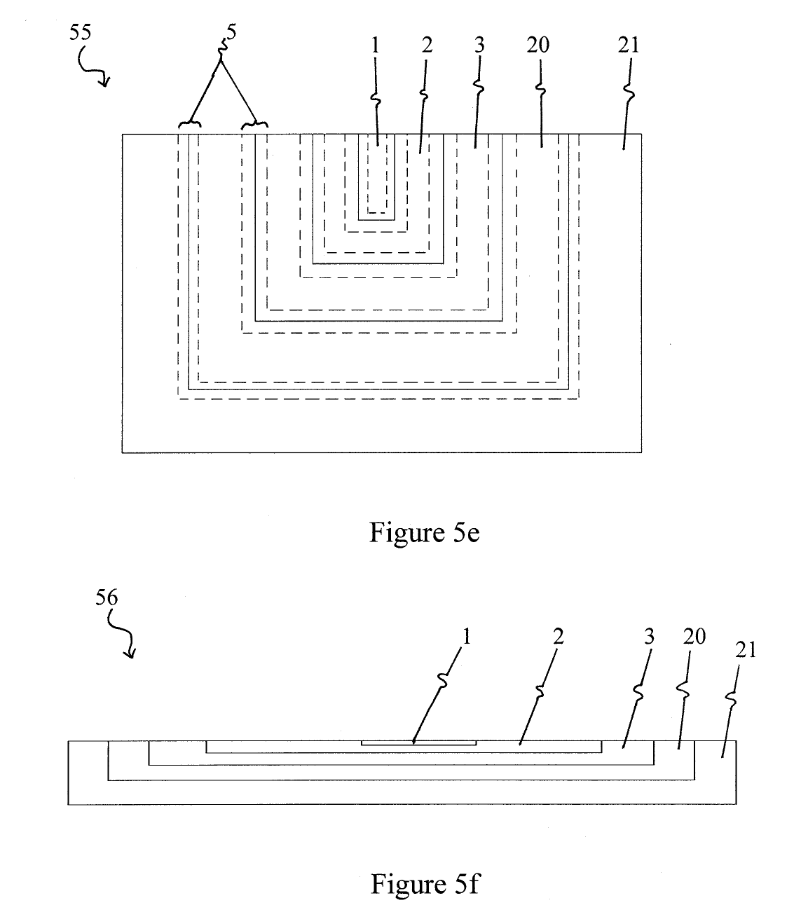

FIGS. 5a-5f illustrate cross sectional views of soil layer configurations in accordance with various embodiments. While the embodiments illustrated in these figures include three soil layers, embodiments may vary as to the number of layers, and any suitable number of layers (e.g. two, four, five, six, seven, etc.) may be included.

FIG. 5a shows a cross sectional view of an embodiment of a soil layer configuration 51 in which layer 1 is disposed vertically within the receptacle 9 such that core layer 1 is in physical contact with a bottom interior surface of receptacle 9. Layer 2 is disposed around/on both sides of core layer 1, and layer 3 is disposed between layer 2 and the sides of receptacle 9. One or more additional layers may be added to the top of layer 1 and may be adapted to retain moisture and/or to protect a plant from frost, wind, cold weather, insect pests, sunlight, or other potentially harmful factors. Layer 4 may be constructed of any suitable material such as paper, fiber, and/or a biodegradable material. One or more of layers 1, 2, 3 and 4 may additionally include an antimicrobial agent or beneficial microbes.

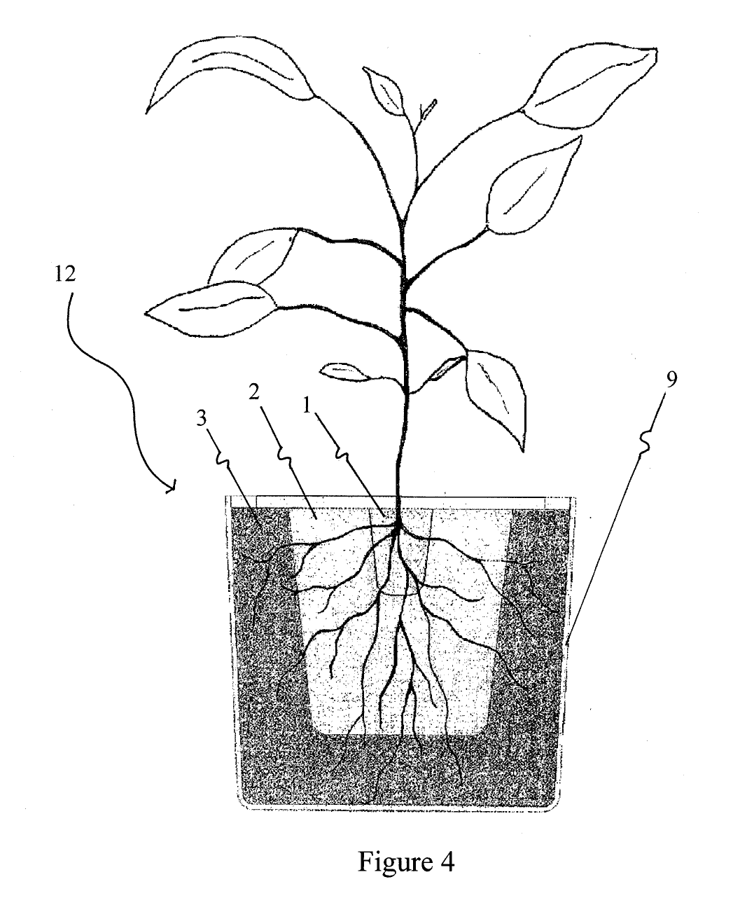

FIGS. 5b and 5c show additional cross sectional views of embodiments of soil layer configurations including nesting cone-shaped layers (configuration 52, FIG. 5b) and horizontal layers vertically stacked within the receptacle (configuration 53, FIG. 5c). In FIGS. 5b and 5c, layer 1 is disposed within/over layer 2 and layer 2 is disposed between layers 1 and 3. Layer 3 is shown disposed between layer 2 and the receptacle 9. Some embodiments lack a layer 3, while others include additional layers 20, 21, 22, 23, etc. Shapes and configurations of layers may vary among embodiments and may be adapted to accommodate root growth patterns of various plants. For example, the embodiment shown in FIG. 5a may be preferred for supporting growth of a plant with predominantly horizontal and/or relatively shallow root growth, while the embodiment shown in FIG. 5c may be preferred for supporting growth of a plant with predominantly vertical and/or relatively deep root growth. The embodiments shown in FIGS. 4a-c and FIG. 5b may be preferred for supporting growth of a plant with an intermediate root growth pattern that is both horizontal and vertical.

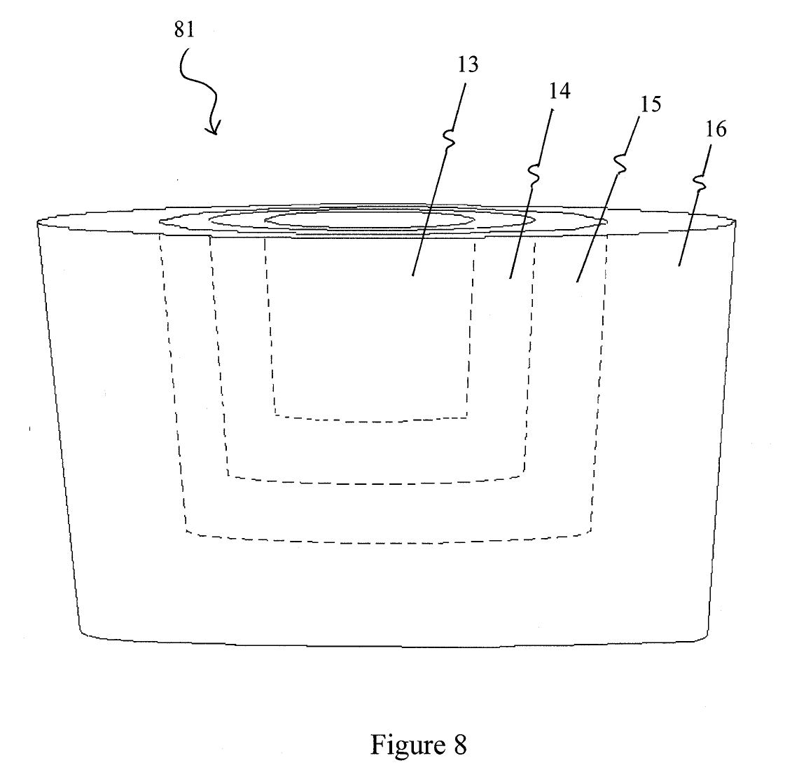

In FIGS. 5a-c, layers are show in direct contact with one another. However, in some embodiments, two or more layers may be separated by a non-soil layer. FIG. 5d shows a cross sectional view of a soil layer configuration 54 (see also FIG. 8) that includes non-soil layers. In FIG. 5d, a non-soil layer 10 is disposed between each of layers 1 and 2, 2 and 3, 3 and 20, and 20 and 21. Layer 21 is also shown disposed above/within a non-soil layer 10. Non-soil layers 10 may be solid, semi-solid, and/or gelatinous, and may be constructed of one or more biodegradable materials. Each non-soil layer 10 shown in FIG. 5d may vary in composition; in some embodiments, each non-soil layer 10 may be of the same or similar composition. In some embodiments, a non-soil layer 10 may be disposed between only some of the soil layers, while in other embodiments a non-soil layer 10 may be disposed between each soil layer. Some embodiments lack a non-soil layer between soil layers. In addition, non-soil layers 10 may be configured to allow root penetration through the non-soil layer(s). In some embodiments, non-soil layers 10 may comprise one or more substances that dissolve/disperse at least partially upon wetting/fluid addition. In an embodiment, non-soil layers 10 may comprise additional plant growth nutrients which may be released into one or more soil layers upon degradation/dissolution of the non-soil layer(s).

In some embodiments, the boundaries between illustrated layers 1, 2 and 3 may be sharply defined, such as by a non-soil layer that acts as a physical divider as shown in FIG. 5d. In other embodiments, layers 1, 2 and/or 3 may mix to some degree in areas where they are in close physical proximity. For example, in an embodiment of a soil layer configuration 55 illustrated in FIG. 5e, layer 1 and layer 2 commingle to some degree, resulting in a mixing zone 5. In this Figure, each mixing zone 5 is shown as the area within each pair of dashed lines, with a solid line within the area to show where layers begin/terminate with respect to one another in embodiments where mixing does not occur. As shown, layer 2 and layer 3 commingle to some degree, resulting in another mixing zone 5. Layers 3 and 20 and layers 20 and 21 are also shown with mixing zones 5. A mixing zone 5 may have physical/compositional characteristics (e.g. water retention, density, nutrient content, pH, etc.) that are intermediates of the physical/compositional characteristics of the layers on both sides of the zone. In some embodiments, such commingling of adjacent layers may be desirable, resulting in a more gradual transition for the growing plant from one layer to the next. In an embodiment, a mixing zone 5 may be deliberately created by mechanical or other physical means, while in other embodiments a mixing zone 5 may form as a result of natural processes (e.g. soil displacement due to root growth, deposition of layers within a receptacle, etc.).

FIG. 5f shows a cross sectional view of an embodiment of a soil layer configuration 56 in which layers 1, 2 and 3 are positioned as shown in FIG. 1 with respect to one another and have been compressed/compacted. In embodiments, layers 1, 2 and/or 3 may decompress/expand in response to addition of a fluid from a top, bottom and/or side surface. In some embodiments, compressed/compacted layers may be provided with a receptacle adapted for measuring an optimal quantity of fluid to add to the layers, with the compressed layers being placed within the receptacle and fluid subsequently added to the receptacle. In other embodiments, compressed layers may be provided without a receptacle. Compressed layers may decompress/expand vertically, horizontally, or both. Layers may be compressed by mechanical force, depressurization/vacuum means, freeze drying, and/or dehydration.

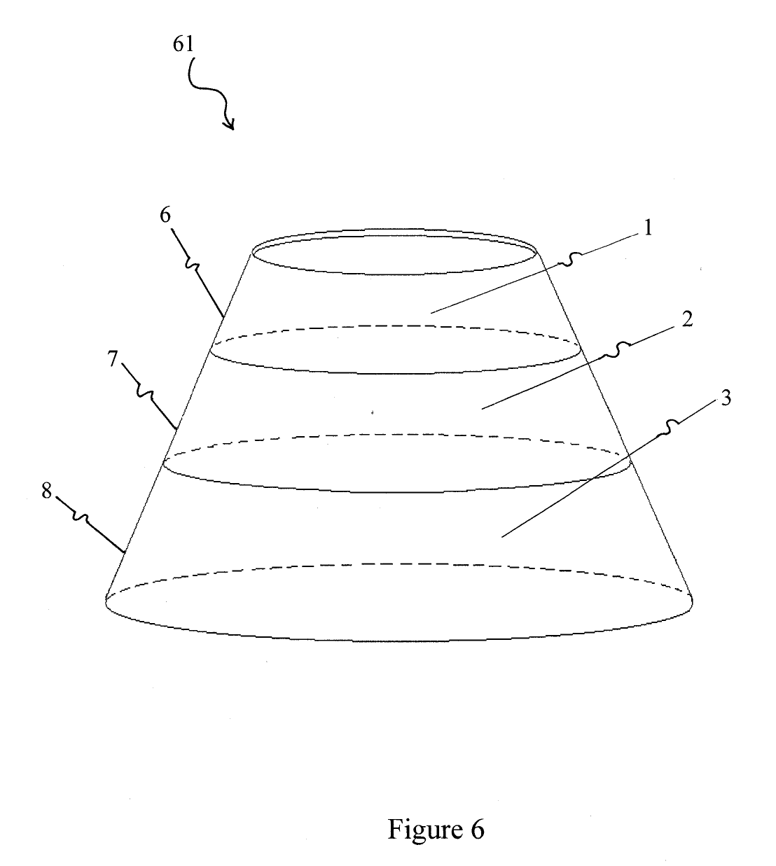

Receptacles in accordance with various embodiments may vary by shape, composition and other physical properties. In some embodiments, receptacles may be shaped for minimization of water loss due to evaporation, optimal stability on surfaces (e.g. difficult to tip or spill), minimization of soil exposure to plant/soil pathogens, minimization of soil use, accommodate root growth patterns, and/or reduction of heat loss from soil layers/plants, etc. FIG. 6 illustrates an embodiment in which a receptacle 61 comprises a series of vertically stacked sub-receptacles 6, 7, and 8. In the illustrated embodiment, sub-receptacle 6 is retained on/partially within sub-receptacle 7, and sub-receptacle 7 is further retained on/partially within sub-receptacle 8, allowing for expanded downward vertical and lateral root growth while minimizing the exposure of the uppermost layer to ambient air. Embodiments vary in number of sub-receptacles and/or vertically stacked units, and a sub-receptacle may be provided with one, two, three or more soil layers.

One or more sub-receptacles may further include means for allowing circulation of air and/or evaporation through a top, bottom or side surface of the sub-receptacle(s); alternatively, air circulation and/or evaporation may occur where sub-receptacles are joined. In some embodiments, sub-receptacles 6, 7, and 8 may be reversibly coupled and/or reversibly locked into position, such that one or more may be removed. For example, a root (e.g. a potato, carrot, onion, etc.) may be easily harvested by removing one or more lower sub-receptacles (e.g. 7 and/or 8) to expose the root, thus allowing the user to sever the root from the plant without pulling the entire plant from the soil. In some embodiments, the removed receptacle may then be re-attached to the upper unit(s) with or without replacing the soil layer(s) within the receptacle in preparation for a new planting.

Soil layers such as layers 1, 2 and 3 may be added to sub-receptacle 6, 7 and 8, respectively. One or more of the sub-receptacles may lack a bottom surface or may comprise a bottom surface that is removable, degradable, dissolvable and/or root-penetrable. In embodiments, one or more of sub-receptacles 6, 7 and/or 8 may comprise surface features operable to mechanically fasten one sub-receptacle to another; alternatively, an external feature such as a strap, a bracket, a casing, etc. In embodiments, one or more receptacles/sub-receptacles may be composed of biodegradable materials such that they may be retained around the growing plant during transplantation.

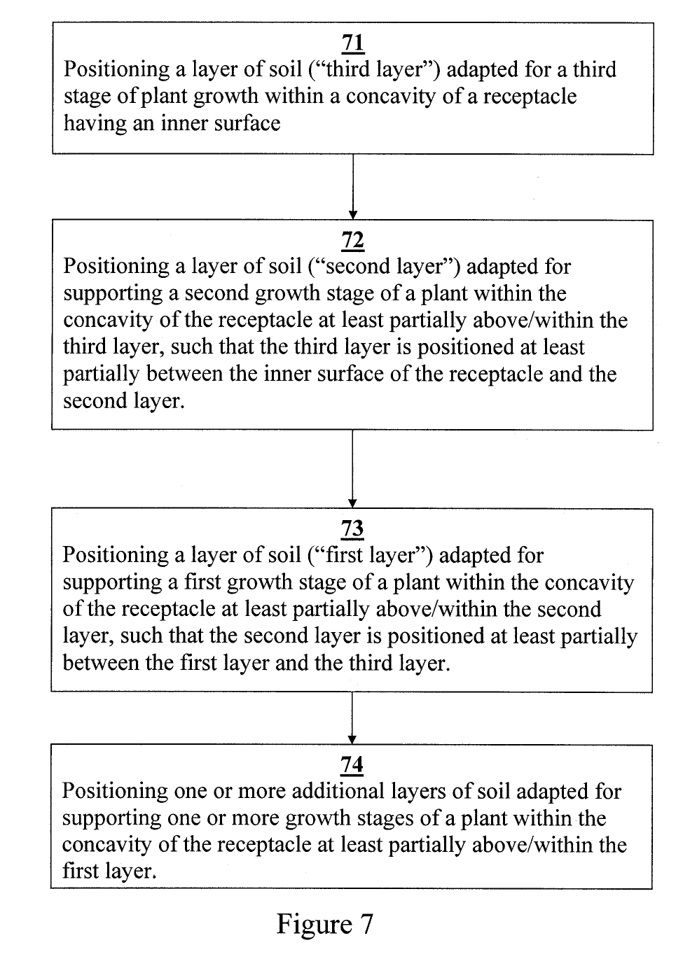

FIG. 7 illustrates a method for practicing embodiments described herein. FIG. 7a shows a flow chart for a method of layering soils to support plant growth. In step 71, a layer of soil (“third layer”) adapted for a third stage of plant growth is positioned within a concavity of a receptacle having an inner surface. Some embodiments may lack this step/layer. In step 72, a layer of soil (“second layer”) adapted for supporting a second growth stage of a plant is positioned within the concavity of the receptacle at least partially above/within the third layer, such that the third layer is positioned at least partially between the inner surface of the receptacle and the second layer. In step 73, a layer of soil (“third layer”) is then disposed over/within the second layer, such that the second layer is positioned at least partially between the first layer and the third layer. Optionally, in step 74, one or more additional layers of soil adapted for supporting one or more growth stages of a plant are positioned within the concavity of the receptacle at least partially above/within the first layer. In embodiments with a step 74, the one or more additional layers of soil may be adapted to support growth stages that occur earlier in time than the growth stage(s) supported by the underlying layers. In some embodiments, a soil layer added in step 74 may support a growth stage by protecting a plant from natural elements such as frost, insects, pathogens, wind, etc. and/or prevent evaporative water loss.

In embodiments that lack a third layer, the second layer may be positioned at least partially between the first layer and the interior surface of the receptacle. In an embodiment, the first, second and third growth stages of a plant may be temporally successive growth stages, with the first growth stage being the earliest growth stage. In embodiments, the first layer may be layer 1 configured as shown in one or more of the preceding Figures and as described in the specification, and/or the second layer may be layer 2 configured as shown in one or more of the preceding Figures and as described in the specification. In embodiments comprising a step 71, the third layer may be layer 3 configured as shown in one or more of the preceding Figures and as described in the specification.

FIG. 8 illustrates an embodiment of an apparatus for supporting plant growth 81 that allows for addition of soil layers at any time during the growth of a plant. In FIG. 8, receptacle 13 includes a first soil layer (such as layer 1), receptacle 14 includes a second soil layer (such as layer 2), receptacle 15 includes a third soil layer (such as layer 3), and an additional receptacle 16 includes an additional soil layer. Receptacles 13, 14, 15 and/or 16 may be provided in varying dimensions to accommodate the placement of a receptacle within another receptacle (see also FIG. 5d).

Receptacles in accordance with various embodiments may be provided with one or more soil layers, as in FIG. 8, or may be provided separately/without soil. In the illustrated embodiment, receptacle 15 is sized to accommodate receptacle 14, with the third soil layer positioned at least partially between an interior surface of receptacle 15 and an exterior surface of receptacle 14. Receptacle 14 is sized to accommodate the second soil layer and receptacle 13, with the second soil layer positioned at least partially between an interior surface of receptacle 14 and an exterior surface of receptacle 13. As a plant grows through these layers, a user may wish to add another soil layer by adding an additional receptacle with an appropriate soil, such as the illustrated receptacle 16. In the illustrated embodiment, receptacle 16 is sized to accommodate an additional soil layer and receptacle 15, with the additional soil layer positioned at least partially between an interior surface of receptacle 16 and an exterior surface of receptacle 15. In embodiments, additional receptacles may be added continuously in unlimited numbers to sustain a plant throughout its entire life cycle.

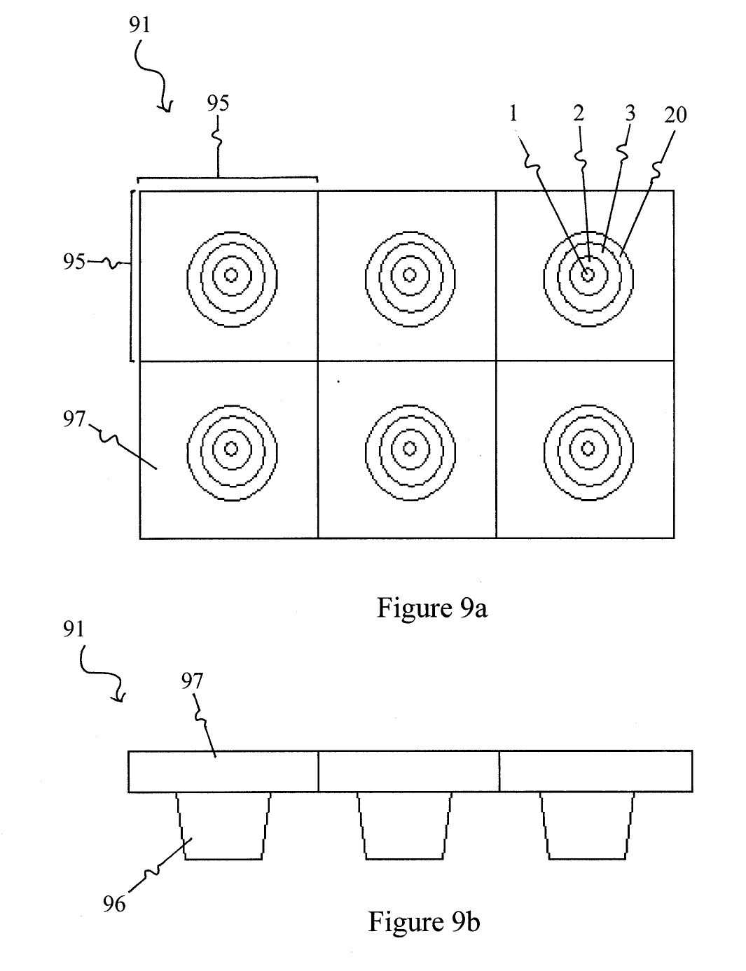

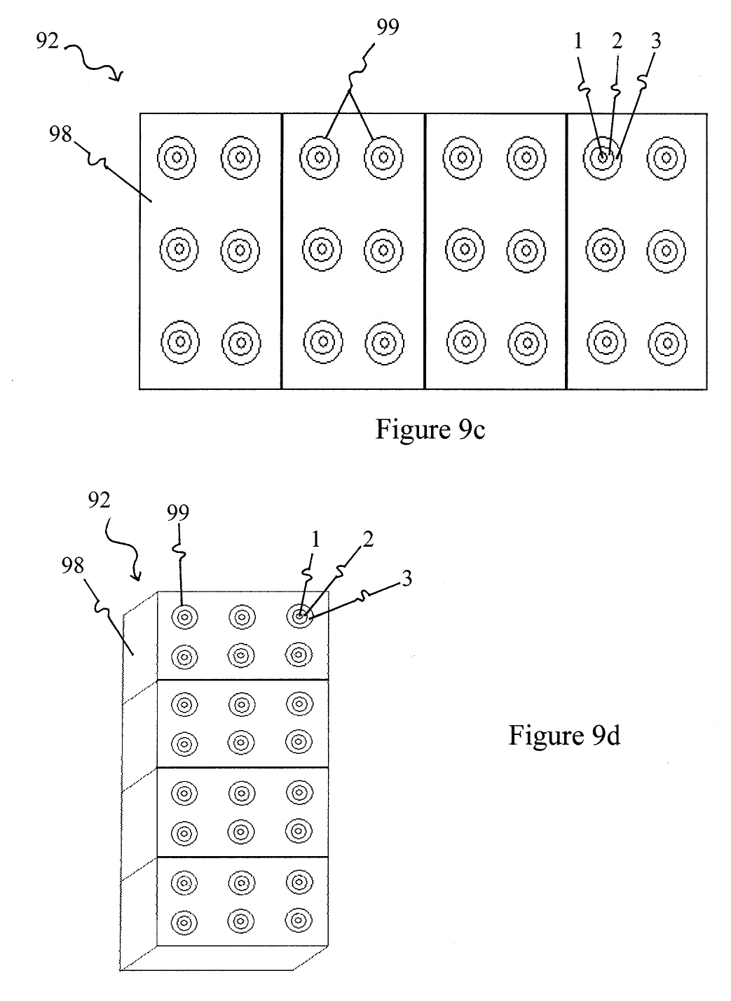

FIGS. 9a-d show illustrations of embodiments of apparatuses for plant cultivation 91 and 92 that incorporate one or more multiple layered soil structures within a unit. FIGS. 9a and 9b show top (FIG. 9a) and bottom (FIG. 9b) views of an embodiment 91 that includes single units that may be attached and detached from one another and incorporate layered soil structures. In some embodiments, a unit 95 may include a receptacle 96 coupled to an attachment member 97. A receptacle 96 may be coupled to another receptacle 96 through one or more attachment members 97.

Various embodiments may include one or more units 95 without an attachment member 97; in some embodiments, units 95 may be configured to be coupled to one another without the use of an attachment member 97. In some embodiments, a unit 95 may comprise both a receptacle and an attachment member formed as a single unit, while in other embodiments these components are separate and may be assembled and/or disassembled.

In other embodiments, such as the embodiment 92 illustrated in FIGS. 9c (top view) and 9d (perspective view), an apparatus 98 may be configured to accommodate one or more receptacles and/or may be constructed with one or more concavities 99 adapted to accommodate a layered soil structure and a plant. An apparatus 98 may be configured to be self-watering, self-feeding, heated/temperature-controlled, and/or stackable, etc. Apparatuses for growing plants in multiples using a single soil are known in the art and will not be further explained herein. Layered soil structures described herein may be applied to such apparatuses to create a novel and advantageous growth environment for one or more plants.

As shown in FIG. 9a/FIGS. 9c-d, a soil assembly comprising layered soils may be disposed within one or more receptacles 96/concavities 99. In the illustrated embodiments, layer 1 (a first soil layer adapted to support a first growth stage of a plant) is shown positioned in the center of a receptacle 96/concavity 99 and is surrounded by layer 2 (a second soil layer adapted to support a second growth stage of the plant). Layer 2 may be at least partially disposed between the first soil layer and an interior surface of receptacle 96/concavity 99. Layer 3 (a third soil layer adapted to support a third growth stage of the plant) is shown disposed around layer 2 and at least partially between layer 2 and an interior surface of receptacle 96/concavity 99. In FIG. 9a, an additional layer 20 is shown. While three soil layers are shown in FIGS. 9c-d, embodiments may vary as to the number of layers within receptacle 96/concavity 99 and may include four, five, six, seven or more layers. In some embodiments, one or more of layers 1, 2 and/or 3 may comprise two or more soil layers.

Embodiments of the present invention may be used both in-doors and out-doors. Embodiments of the present invention may be used in various applications including, but not limited to, flower/vegetable gardening, container gardening, growing plants intended for transplantation into ground soil, and small-scale or large-scale asexual propagation of plants. Embodiments of the present invention may be beneficial to any scale of nursery or planting operation, including but not limited to both home gardeners and commercial gardeners. By using various embodiments, both the home gardeners and commercial gardeners may experience reduced work load and increased production. For commercial gardeners the reduction of workload and increase of production may translate directly into reduced overall costs and increased profits. In addition the rate of loss as a result of transplant would be reduced.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present invention be limited only by the claims and the equivalents thereof.

What is claimed is:

1. A composite soil configuration for supporting plant growth, comprising:
a first soil layer adapted to support a first plant growth stage; and
a second soil layer adapted to support a second plant growth stage, the second soil layer disposed proximally to the first soil layer in a manner such that plant roots may engage the second soil layer in the second plant growth stage.

2. The composite soil configuration of claim 1, further including a third soil layer adapted to support a third plant growth stage, the third soil disposed proximally to the second soil layer in a manner such that plant roots may engage the third soil layer in the third plant growth stage, and the second soil layer at least partially disposed between the first soil layer and the third soil layer.

3. The composite soil configuration of claim 1, wherein the first soil layer is adapted to support germination.

4. The composite soil configuration of claim 1, wherein the second soil layer is adapted to support at least one of drainage, moisture retention, and aeration of the first soil.

5. The composite soil configuration of claim 1, wherein the density of the second soil is greater than the density of the first soil.

6. The composite soil configuration of claim 2, wherein the density of the third soil layer is greater than the density of the second soil layer.

7. The composite soil configuration of claim 1, wherein at least one of the first soil layer and the second soil layer is provided in a compressed form to be decompressed by addition of a fluid.

8. The composite soil configuration of claim 1, wherein both the first soil layer and the second soil layer are provided in a compressed form to be decompressed by addition of a fluid.

9. The composite soil configuration of claim 1, wherein the second soil layer is positioned generally concentrically around the first soil layer.

10. The composite soil configuration of claim 1, wherein the second soil layer is disposed horizontally with respect to the first soil layer.

11. The composite soil configuration of claim 1, wherein second soil layer is disposed vertically with respect to the first soil layer.

12. The composite soil configuration of claim 1, wherein an intermediate layer is positioned at least partially between the first soil layer and the second soil layer, the intermediate layer being a non-soil layer configured to be penetrable by a root.

13. A method for layering soils to support plant growth, comprising:
positioning a first soil layer comprising a first soil within a concavity of a first receptacle having an inner surface, the first soil layer adapted for supporting a first growth stage of a plant; and
positioning a second soil layer comprising a second soil within the concavity of the first receptacle, the second soil layer adapted for supporting a second growth stage of the plant,
wherein the second soil layer is at least partially disposed between a portion of the first soil layer and the inner surface of the first receptacle, and wherein the first growth stage is an earlier occurring stage of plant growth than the second growth stage.

14. The method of claim 13, wherein the first receptacle is configured to be penetrable by one or more roots of the plant.

15. The method of claim 13, further comprising providing a third soil layer comprising a third soil in the first receptacle, the third soil layer adapted for supporting a third growth stage of the plant.

16. The method of claim 15, wherein the first soil is the same as the second soil or the third soil.

17. The method of claim 15, wherein the third growth stage is a later occurring growth stage than the first and second growth stages, and wherein the third soil layer is at least partially disposed between a portion of the second soil layer and the inner surface of the first receptacle.

18. The method of claim 13, further comprising positioning the second soil layer such that the first soil layer is not in direct physical contact with the inner surface of the first receptacle.

19. The method of claim 13, further comprising positioning the second soil layer such that the first soil layer is in direct physical contact with a portion of the inner surface of the first receptacle.

20. The method of claim 13, further comprising providing a third soil layer comprising a third soil disposed within a concavity of a second receptacle, the concavity being configured to accommodate both the third soil layer and the first receptacle.

21. The method of claim 9, wherein the second receptacle is biodegradable.

22. The method of claim 20, wherein the second receptacle is configured to be penetrable by one or more roots of the plant.

23. The method of claim 13, the method further including positioning an intermediate layer at least partially between the first soil layer and the second soil layer, the intermediate layer being a non-soil layer configured to be penetrable by a root.

24. The method of claim 22, the method further including:
removing the first receptacle from the second soil layer; and
severing a root portion of a plant disposed within the second soil layer, wherein at least part of the root portion of the plant remains disposed within the first soil layer.

25. The method of claim 20, the method further including:
removing the second receptacle from the first receptacle; and
severing a root portion of a plant disposed within the third soil layer, wherein at least part of the root portion of the plant remains disposed within the first and the second soil layers.

26. An apparatus for plant cultivation, comprising
a first plurality of units, each unit comprising a receptacle member with an interior surface and each unit configured to be mechanically coupled to another unit; and
a soil assembly disposed within each receptacle member, the soil assembly further comprising
a first soil layer adapted to support a first growth stage of a plant; and
a second soil layer adapted to support a second growth stage of the plant, the second soil layer being at least partially disposed between the first soil layer and an interior surface of the receptacle member.

27. The apparatus of claim 25, further comprising a third soil layer adapted to support a third growth stage of the plant, the third soil layer being at least partially disposed between the second soil layer and the interior surface of the receptacle member.
